(19) United States
(12) Patent Application Publication
(10) Pub. No.: US 2005/0071887 A1
(43) Pub. Date: Mar. 31, 2005

(54) Information processing apparatus and information processing method

(75) Inventor: Osamu Yoshida, Kawasaki-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/945,257

(22) Filed: Sep. 21, 2004

(30) Foreign Application Priority Data
Sep. 26, 2003 (JP) 2003-336214

(51) Int. Cl. H04N 7/16; H04N 7/025; H04N 7/10

(52) U.S. Cl. 725/135; 725/32

(57) ABSTRACT

An information processing apparatus comprises a receiving portion which receives a broadcast signal and outputs a video signal, a communication portion which outputs an image signal on the basis of a signal acquired via a network, a display portion which displays at least one of the video signal from the receiving portion and the image signal from the communication portion, and a control portion which, upon receipt of the video signal from the receiving portion and the image signal from the communication portion, controls the video signal to be supplied as a first display to the display portion according to a command signal, then changes the display and controls the image signal to be supplied as a second display to the display portion, and an elapsed time interval from the change to be displayed on the display portion.

### CROSS-REFERENCE TO RELATED APPLICATIONS

This application is based upon and claims the benefit of priority from prior Japanese Patent Application No. 2003-336214, filed Sep. 26, 2003, the entire contents of which are incorporated herein by reference.

### BACKGROUND OF THE INVENTION

1. Field of the Invention

The present invention relates to a multifunction type information processing apparatus and method having a receiving function such as a mobile television and another display function such as a browser display function such as a network, for example.

2. Description of the Related Art

In recent years, with the development of communication infrastructure such as an ADSL (Asymmetric Digital Subscriber Line) or optical communication or the spread of a portable telephone, there has been developed an environment in which an access can be provided to the Internet. Among them, a PC (personal computer) is basically mainly used as a terminal for providing an access to the Internet. However, there has been introduced a TV or a recording or reproducing machine having an Internet connection function added thereto.

In addition, a function for providing an access to the Internet even at the outside via a portable telephone, a public wireless LAN or the like has been developed, thereby making it possible to provide an access by using equipment such as a portable telephone, notebook type PC or PDA. A PC having a TV tuner incorporated therein or a TV tuner for the PC is prevailingly known, and a device for viewing a TV at an Internet terminal is also prevailingly known.

With commencement of a mobile broadcast or a digital terrestrial broadcast, there is a possibility that a TV exclusively used for a mobile unit will be prevailingly known. It is expected that such a device also has an Internet access function in the near future. Further, it is also expected that a portable telephone which is already capable of providing an Internet access additionally has a function for receiving a broadcast oriented to such a mobile unit. In the near future, it is expected that an increased number of terminals has both of a function serving as a communication terminal and a TV receiving function.

In such a terminal having a plurality of functions, there are a variety of screen sizes or resolutions which can be displayed depending on its shape or the like. A PC has a comparatively large screen size and a high resolution, thus making it possible to display a TV screen and an Internet screen at the same time in a multi-window format. However, a portable telephone, a TV for a mobile unit or the like must have a small cabinet because of its portability, and becomes small in display size. Even if resolution is high, the display cannot be visible because it is too small. Because of this, it is not easy to make a multi-window display. Therefore, a simple window display for changing a screen on an application by application basis is mainly used.

As a prior art of such an information apparatus (Jpn. Pat. Appln. KOKAI Publication No. 11-355682), there is disclosed an information output apparatus having a function for displaying Internet information, wherein, when a commercial message starts while in receiving a broadcast, a user press a specific switch, thereby displaying an Internet screen only during a commercial message according to a user predetermined time interval. In this manner, the user can view a broadcast program and Internet according to one's convenience.

However, in the prior art, a browser screen is displayed by a predetermined time interval. A variety of aspects can be assumed in communication with viewing of a broadcast screen such as an actual television and viewing of a browser screen. As an example, the following case is assumed. That is, assume that, when the user views a broadcast screen, the user changes it to the browser screen to start viewing the browser screen; and then, the user wants to continue viewing the browser screen for a comparatively long time, but wants to view the broadcast screen to some extent. In such a case, there has been a problem that such a user's demand cannot be met merely by automatically changing a screen after a predetermined time interval has elapsed as in the prior art.

### BRIEF SUMMARY OF THE INVENTION

According to one aspect of the present invention, there is provided an information processing apparatus comprises a receiving portion which receives a broadcast signal and outputs a video signal; a communication portion which outputs an image signal on the basis of a signal acquired via a network; a display portion which displays at least one of the video signal from the receiving portion and the image signal from the communication portion; and a control portion which, upon receipt of the video signal from the receiving portion and the image signal from the communication portion, controls the video signal to be supplied as a first display to the display portion according to a command signal, then changes the display and controls the image signal to be supplied as a second display to the display portion, and further, an elapsed time interval from the change to be displayed on the display portion.

### BRIEF DESCRIPTION OF THE SEVERAL VIEWS OF THE DRAWING

FIG. 1 is a block diagram depicting an example of a configuration of an information processing apparatus according to the present invention;

FIG. 2 is a flowchart showing an example of processing of an information processing apparatus according to a first embodiment of the present invention;

FIG. 3 is a view showing an operating screen showing an example of the processing of the information processing apparatus according to the invention;

FIG. 4 is a view showing a setting screen showing an example of the processing of the information processing apparatus according to the invention;

FIG. 5 is a flowchart showing an example of processing of an information processing apparatus according to a second embodiment of the present invention;

FIG. 6 is a flowchart showing an example of processing of an information processing apparatus according to a third embodiment of the present invention;

FIG. 7 is a flowchart showing an example of processing of an information processing apparatus according to a fourth embodiment of the present invention;

FIG. 8 is a block diagram depicting an example of a configuration of an information processing apparatus according to a fifth embodiment of the present invention; and

FIG. 9 is a block diagram depicting another example of a configuration of a mobile communication portion which the information processing apparatus according to the fifth embodiment.

### DETAILED DESCRIPTION OF THE INVENTION

Hereinafter, an information processing apparatus according to the present invention will be described in detail with reference to the accompanying drawings.

<Information Processing Apparatus According to First Embodiment of the Present Invention>

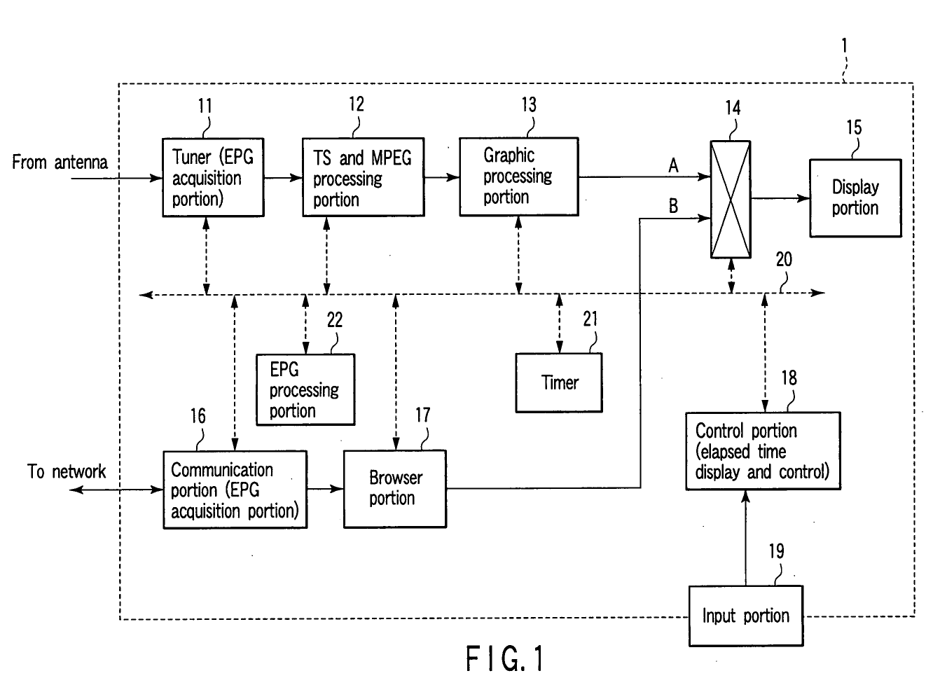

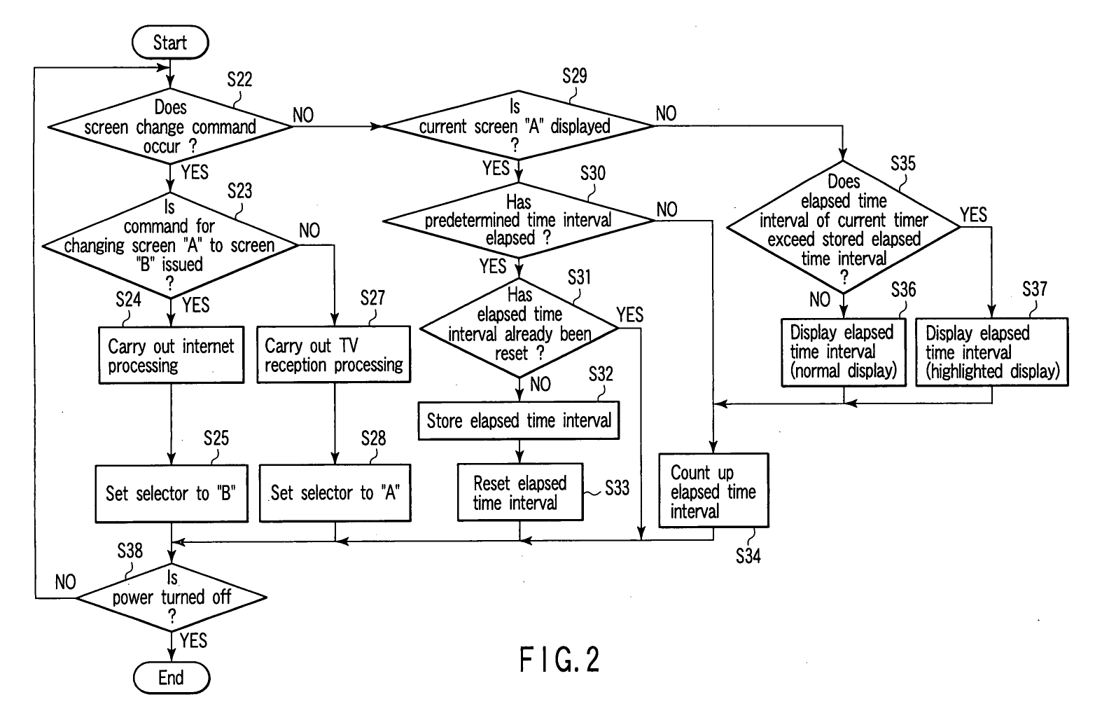

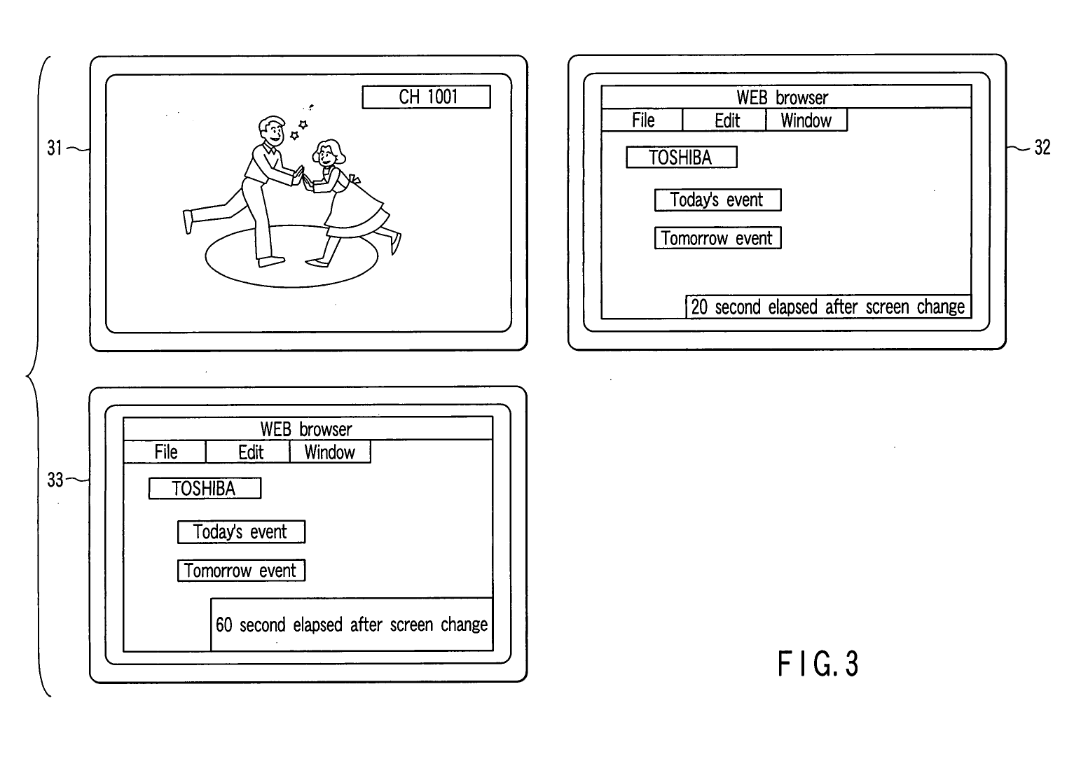

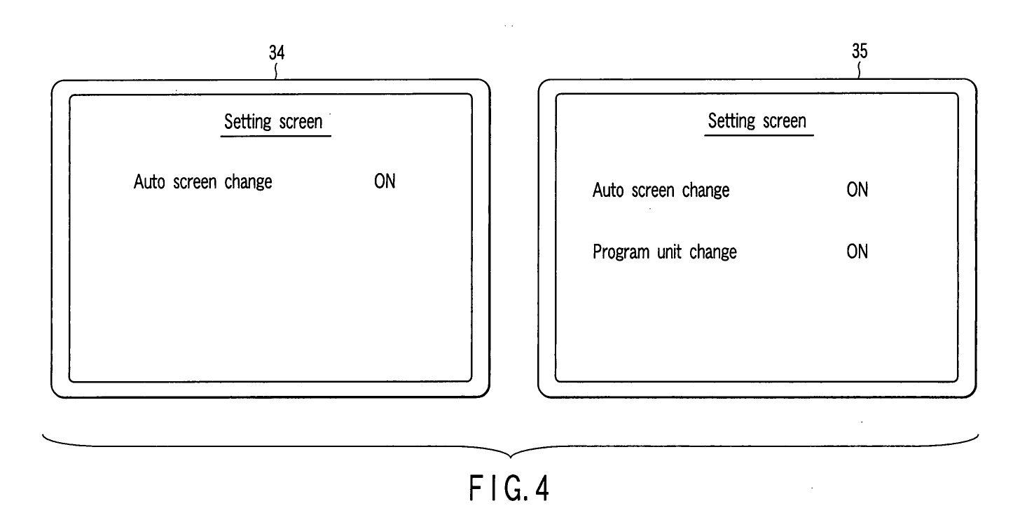

Hereinafter, the present embodiment will be described with reference to the accompanying drawings. FIG. 1 is a block diagram depicting an example of a configuration of an information processing apparatus according to the present invention. FIG. 2 is a flowchart showing an example of processing of an information processing apparatus according to a first embodiment of the present invention. FIGS. 3 and 4 are views each showing an operating screen showing an example of processing of the information processing apparatus.

(Configuration)

In FIG. 1, an information processing apparatus 1 according to the present invention comprises a tuner 11 for, upon the receipt of a signal from an antenna, choosing and receiving one of programs broadcast by a satellite broadcast, a terrestrial broadcast, CATV or the like, the tuner being connected to a data bus 20. Further, this apparatus comprises: a TS and MPEG processing portion 12 for carrying out de-maximization of a transport stream (TS) chosen by the tuner 11 or decoding of MPEG; a graphic processing portion 13 for carrying out graphic processing of a decoded video signal; a timer 21; and an EPG processing portion for carrying out program reservation processing using EPG information described later, which are connected to the data bus 20.

Furthermore, the information processing apparatus 1 has a communication portion 16 such as a modem connected to a network such as Internet; and a browser portion 17 for processing information obtained via the communication portion in a displayable signal manner. This apparatus has a selector 14 supplied with this output and an output of the graphic processing portion 13; and a display portion 15 for displaying an image in response to an output of an image signal selected by the selector 14. It is preferable that this communication portion 16 has a wireless function. It is possible to acquire desired information by making connection to, for example, the Internet or the like, via the communication portion 16 while using the information processing apparatus 1 in a portable manner.

Furthermore, the information processing apparatus 1 has a control portion 18 for controlling a whole operation, the control portion being connected via the data bus 20; and an input portion 19 for supplying a command signal, an operating signal and the like to the control portion 18, and further, upon the receipt of operating information or the like from the control portion 18, displaying the operating information on a liquid crystal display screen, a light emitting diode (LED) and the like. The input portion 19 is provided to receive a user operating command or to make a simple operating display. This input portion includes operating switches on a receiver device 1 or a remote controller caused by wireless communication.

In the first embodiment according to the present invention, there is provided an information processing apparatus for, in the case where a broadcast screen such as a TV is changed to a browser screen such as Internet, displaying an elapsed time interval after the change.

(Operation)

Now, an operation of the information processing apparatus 1 according to the first embodiment of the invention will be described below in detail with reference to the flowchart of FIG. 2. The flowchart of FIG. 2 shows a case of displaying a broadcast screen 31 (A); a case of displaying a browser screen 32 (B) of the Internet; a case of changing the broadcast screen 31 (A) to the browser screen 32 (B); and a case of changing the browser screen 32 (B) to the broadcast screen 31 (A), respectively. In this flowchart, by repeating the steps from start to end, for example, “n” times for a second, proper processing is carried out in correspondence with each of the above-described cases.

In this flowchart, in the case where a screen change input has been made from the input portion 19 (S22), the change direction is determined (S23). When a current screen is the broadcast screen 31 (A), and is changed to the browser screen 32 (B) (S23), for example, information is acquired from the Internet by working of the communication portion 16 and the browser portion 17 on the basis of a control of the control portion 18, and the acquired information is processed by the browser portion 17 so as to be displayed by a browsing application (S24). Then, the selector 14 changes its selection from the screen 31 (A) to the screen 32 (B), whereby the browser screen is displayed on the display portion 15 (S25).

When the browser screen 32 (B) is changed to the broadcast screen 31 (A) in step S23, a desired broadcast signal is chosen from signals from the antenna by the tuner 11; a stream signal is demodulated by the TS and MPEG processing portion 12; and graphic processing is applied by the graphic processing portion 13 (S27). Then, the selector 14 chooses the screen 31 (A) (S28), whereby a video image is displayed in response to the broadcast signal on the display portion 15.

Then, the processing in this flowchart returns to the starting step S21 unless the power source is turned off (S38). In the case where no screen change command occurs (S22), determination of a currently displayed screen is made (S29). When the currently displayed screen is the broadcast screen 31 (A), determination is made as to whether or not a predetermined amount of times (for example, 1 minute or more) has elapsed after this screen 31 (A) has been displayed (S30). When the predetermined amount of times has not elapsed yet, the upward counting of the elapsed time interval is carried out (S34). That is, although the broadcast screen 31 (A) is displayed here, the upward counting is carried out as to whether or not a sufficient amount of times has elapsed after the browser screen 32 (B) has been changed to the broadcasting screen 31 (A).

In the case where it is determined that a predetermined amount of times has already elapsed in step S30, it is determined whether or not an elapsed time interval has already reset, the elapsed time interval indicating “a time at which the browser screen 32 (B) has returned to the broadcast screen 31 (A)” (S31). When resetting has already been completed, nothing is done. When resetting has not been completed yet, an elapsed time interval is stored, the elapsed time interval indicating “an interval at which the browser screen 32 (B) returns to the broadcast screen 31 (A) after the broadcast screen 31 (A) has been changed to the browser screen 32 (B)” (S32), and a timer is reset (S33). At this time, the stored elapsed time interval is a reference value for comparison in step S35 described later.

When it is determined that the current screen is the browser screen 32 (B) in step S29, it is determined whether or not an elapsed time interval of a current timer exceeds the stored elapsed time interval (S35). If not, the elapsed time interval is displayed on the screen by controlling the browser portion 17 (S36). The elapsed time interval used here denotes the immediately preceding elapsed time interval stored in step S32, and, for example, a time corresponding to a CM interval.

If the stored elapsed time interval is greater than an elapsed time interval of the current timer, it is determined that the already set elapsed time interval is exceeded, for example, that the browser screen is continuously displayed. Then, as shown in a screen 33 of FIG. 3, the elapsed time interval is displayed by highlighting it with color, blinking, font size and the like (S37). In addition, it is preferable that the elapse of a predetermined time interval is specifically indicated via a message.

By using such operating procedures, in the case where an operation has been made such that the current screen is returned to the browser screen if CM is in progress yet after the current screen has been momentarily returned to the original screen in order to check whether or not the CM has terminated, for example, in the case where the browser over the Internet is accessed only while in CM, the elapsed time interval is not reset. Therefore, the fact that the current screen has been temporarily returned to the broadcast screen is not counted, making it possible to measure a substantial “interval at which the browser screen 32 (B) returns to the broadcast screen 31 (A) after the broadcast screen 31 (A) has been changed to the browser screen 32 (B)”. Hence, it is possible to easily carry out time measurement such as CM. Here, it is presumed that a CM time in a television program is almost equal to another.

For example, if a change between a broadcast screen and a browser screen is made by a user manual operation during a first CM, in the case where such an operation has been made again during a second or subsequent CM, the CM time is already known, and thus, the browser screen may be returned to the broadcast screen after a predetermined time interval has elapsed. In addition, in the case where the elapsed time interval has further passed, screen characters or the like are displayed to be highlighted as shown in the screen 33 of FIG. 3. Thus, the user can recognize that the time when the CM terminates has elapsed.

In this manner, according to the present invention, in a receiver device has a broadcast receiving function and an Internet connecting function, when a current screen is changed to another screen while in broadcast receiving, an elapsed time interval after the change is displayed. This display can serve as a standard for a timing for returning to the original screen, and even an information processing apparatus of small screen size can be efficiently utilize a screen.

The present embodiment has described an example of providing an access to the Internet while in broadcast receiving. However, the present embodiment can also be applied to a case of providing an access to a broadcast while in Internet connection. Of course, the present embodiment can be applied to screen change of a plurality of applications without being limited to a combination of such a broadcast and the Internet.

<Information Processing Apparatus According to Second Embodiment of the Present Invention>

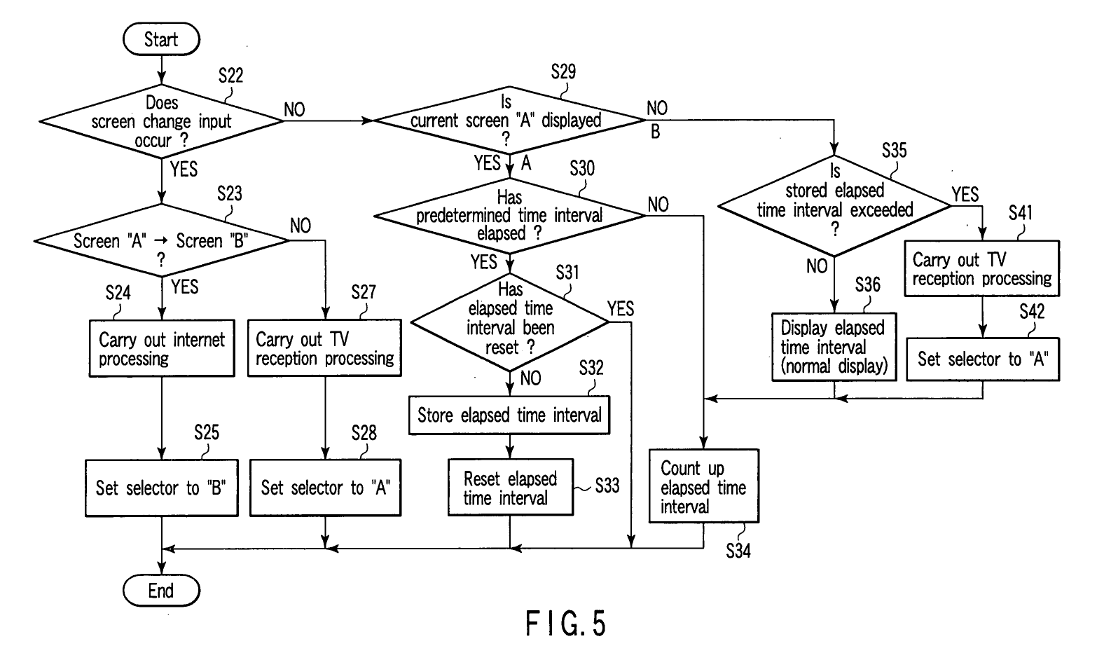

According to a second embodiment of the present invention, there is provided an information processing apparatus capable of automatically returning to a broadcast screen after a predetermined time interval has elapsed after a broadcast screen such as a television has been changed to another screen (a browser screen such as Internet). FIG. 4 is a view showing a setting screen showing an example of processing of the information processing apparatus according to the invention. FIG. 5 is a flowchart showing an example of processing of the information processing apparatus according to the second embodiment of the invention.

The flowchart of FIG. 5 is basically identical to that of FIG. 2 except that processing operations in steps S41 and S42 are different. Thus, a description of common portions is omitted, and only different elements are described below.

First, by setting based on a user operation or by default setting, as shown in a setting screen 34 of FIG. 4A, automatic screen change is turned ON, whereby this operating mode can be established. In step S22, when no screen change command occurs and the current screen is the screen 32 (B) (S29), if an elapsed time interval of the current timer reaches a stored elapsed time interval (S35), the browser screen is automatically changed to the broadcast screen. That is, the tuner 11 is controlled under the control of the control portion 18, and TV reception processing is carried out (S41). The selector 14 chooses the screen 31 (A), whereby a broadcast screen is displayed on the display portion 15 (S42). The other processing operations are identical to those in the flowchart of FIG. 2.

By automatically changing the screen in this way, for example, the browser screen changed from the broadcast screen is automatically changed to the broadcast screen after 90 seconds according to the set time (for example, 90 seconds) automatically stored in step S32 of FIG. 2. In this manner, when the user views a television program on the broadcast screen during the second or subsequent CM, even if the user views the browser screen by making an operation for changing the broadcast screen to the browser screen during the CM, the current screen is automatically returned to the broadcast screen after 90 seconds. This makes it possible for the user to avoid missing a timing of restarting the program after CM has terminated.

<Information Processing Apparatus According to Third Embodiment of the Present Invention>

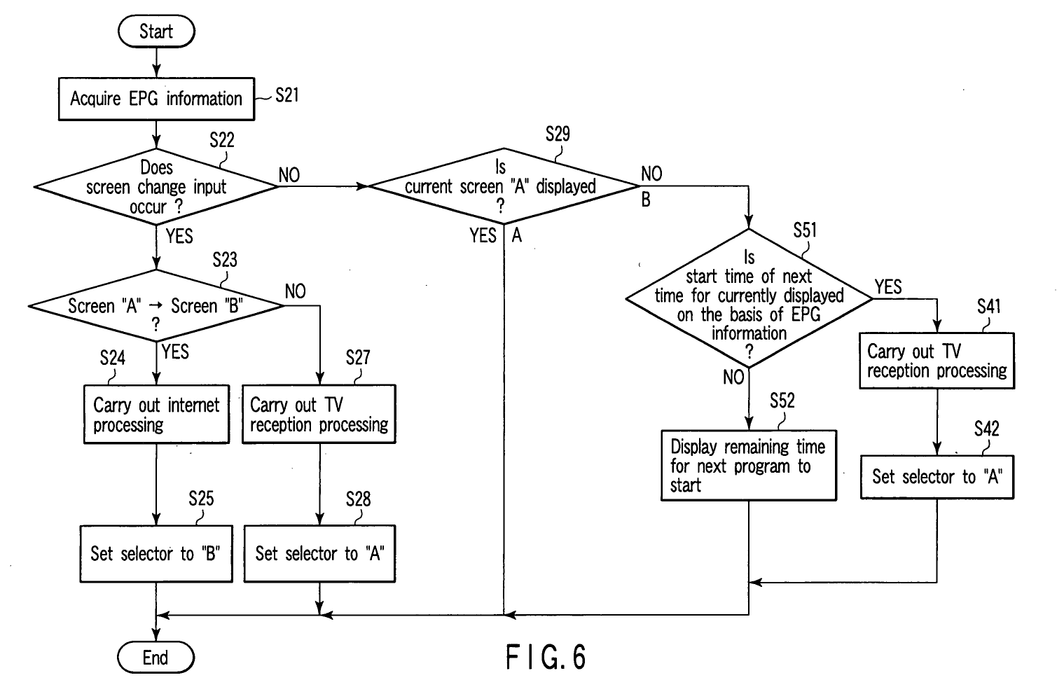

Now, according to a third embodiment of the present invention, there is provided an information processing apparatus capable of changing a broadcast screen such as a television to another screen (browser screen such as Internet), followed by producing a display based on a start time of a next program based on the acquired electronic program information, and automatically returning to the broadcast screen at the start time of the next program. FIG. 4 is a view showing a setting screen showing an example of processing of the information processing apparatus according to the invention. FIG. 6 is a flowchart showing an example of processing of the information processing apparatus according to the second embodiment of the present invention.

The flowchart of FIG. 6 includes steps 22 to S29 which are common to those of the flowchart of FIG. 2. A description of these steps is omitted here, and only different steps are described below.

First, by setting based on the user operation or by default setting, as shown in a setting screen 35 of FIG. 4, automatic screen change is turned ON, and a program unit change is turned ON, whereby this operating mode can be established. For example, EPG (Electric Program Guidance) information which is electronic program information is acquired in accordance with step S21, the EPG information is acquired by working of an acquisition portion of the tuner portion 11 or working of the communication portion 16, and the acquired information is stored in a storage region such as the control portion 18. It is preferable that the EPG information is automatically acquired in accordance with the set specification. In addition, it is preferable that this information be automatically acquired by automatic acquisition of a predetermined time interval such as one time per day or program determination of an inactive time of the tuner portion 11 or communication portion 16.

That is, on the setting screen 35, when auto screen change is turned ON, and program unit change is turned ON, it is detected that a program of a broadcast signal received by the receiving portion has been changed. Then, the control portion 18 controls the screen 32 (B) to be changed to the screen 31 (A).

In step S22, when no screen change command occurs, and the current screen is the screen 32 (B) (S29), a current time measured by the control portion 18 or the like is compared with a start time of a next program of a channel in receiving indicated by EPG information; and it is determined whether or not the current time reaches the start time (S51). If not, a time from the current time to the next program start is counted down, and is displayed (S52). Even if the current time does not reach the next program start time, if a predetermined time interval (for example, before 5 minutes) is established until the next program start time has reached, the remaining time for the next program to start is displayed by highlighting it by color, blinking, font size and the like, as is the case of the screen 33 of FIG. 3, in the sense of warning. In addition, it is preferable that the above remaining time for the next program to start be specifically displayed via a message. Furthermore, it is preferable that a remaining predetermined time interval for a program to start be warned to a user by voice.

When it is determined that the current time reaches the next program start time in step S51, the tuner portion 11 and TS/MPEG processing portion 12 etc. are driven under the control of the control portion 18, and a video signal is outputted in response to a broadcast signal (S41). Then, the selector 14 chooses the screen 31 (A) (S42), whereby automatic switch processing from the browser screen to the broadcast screen can be carried out. Even if the current time does not reach the next program start time completely, for example, it is preferable that switch processing is first carried out within the range of a predetermined time interval (for example, before 10 seconds).

By providing such a function, after a program has terminated, for example, even if browsing of an associated site is carried out at a time for a next program to start, the current screen is automatically changed to a TV screen when the next program starts. This makes it possible to prevent the user from missing the next program in the case where an attempt is made to watch it.

In the case where an attempt is made to display a time for a next program to start, although automatic screen change or a program unit change is not made, an exclusive mode is provided to choose the time. This display can be made by acquisition of EPG information in step S21 and by processing operations in steps S51 and S52. When the current time reaches the next program start time, it is preferable that start of the next program is notified by changing how to display a time in a highlighting manner for the next program to start, as in the first embodiment. In this time, it is possible to change the browser screen to the next program broadcast screen by the user manual operation. The specification for this switch processing is set by the user operation on the screen shown in FIG. 4 or on a more detailed screen. It is preferable that a second screen (such as a browser screen) be changed to a first screen (broadcast screen) on the bas is of this specification.

It is preferable that display or switch processing of the first and second embodiments is carried out at the same time when the processing of the above-described third embodiment is carried out. These choices can be arbitrarily made according to the user preference.

<Information Processing Apparatus According to Fourth Embodiment of the Present Invention>

Now, according to a fourth embodiment of the present invention, a remaining time interval for a next program to start is displayed on the basis of EPG information after a screen has been changed on the basis of a preset program reservation.

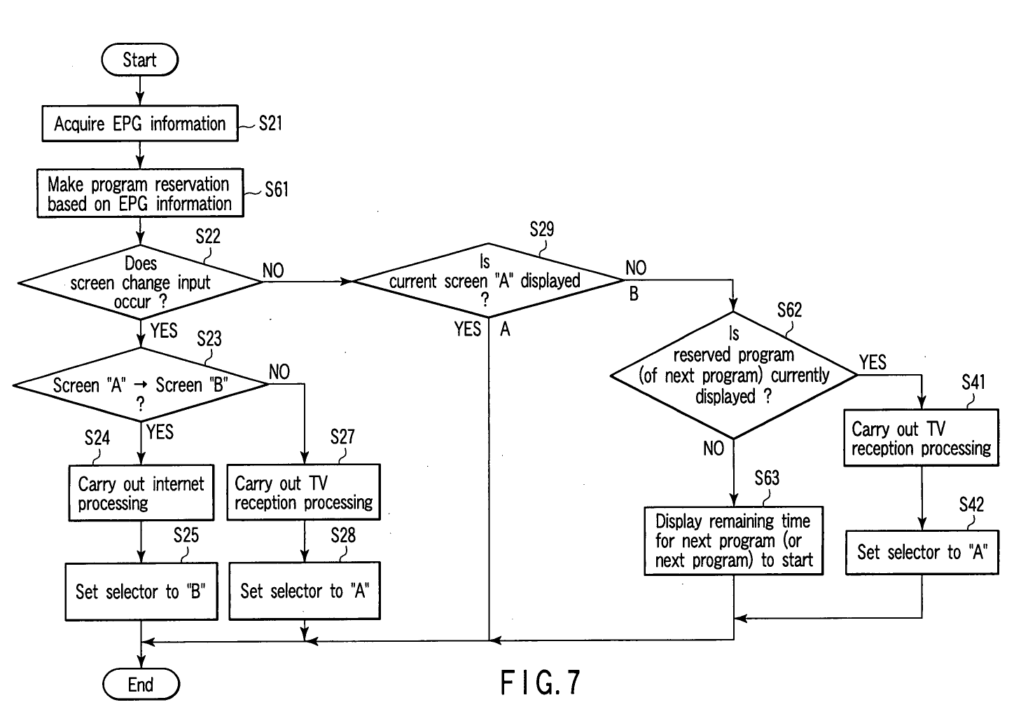

In the flowchart of FIG. 7, a description of steps 21 to S29 which are common portions to those of FIG. 6 is omitted, and only different portions will be described below.

In step S61, the start of a specific program is reserved on the basis of the EPG information acquired by EPG acquisition portions 11, 16. When the specific broadcast program is reserved here, the screen 31 (A) is not displayed in step S62, and if the reserved program (or next program) preset in step S61 is currently is a start time, the remaining time for the reserved program (or next program) to start is displayed based on the EPG information and current time (S63).

By providing such a function, after terminating a program which the user has been arbitrarily set to be reserved, even if browsing of, for example, an associated site is carried out at a time interval for the next program to start, the current screen is automatically changed to the TV program when the reserved program starts. Thus, the user can carry out browsing of, for example, an Internet page efficiently, until the reserved program has started without missing the desired reserved program.

It is preferable that, in this fourth embodiment, the display or change processing of the first and second embodiments and the above processing of the third embodiment be carried out at the same time. These selections can be arbitrarily made according to the user's desire.

<Information Processing Apparatus According to Fifth Embodiment of the Present Invention>

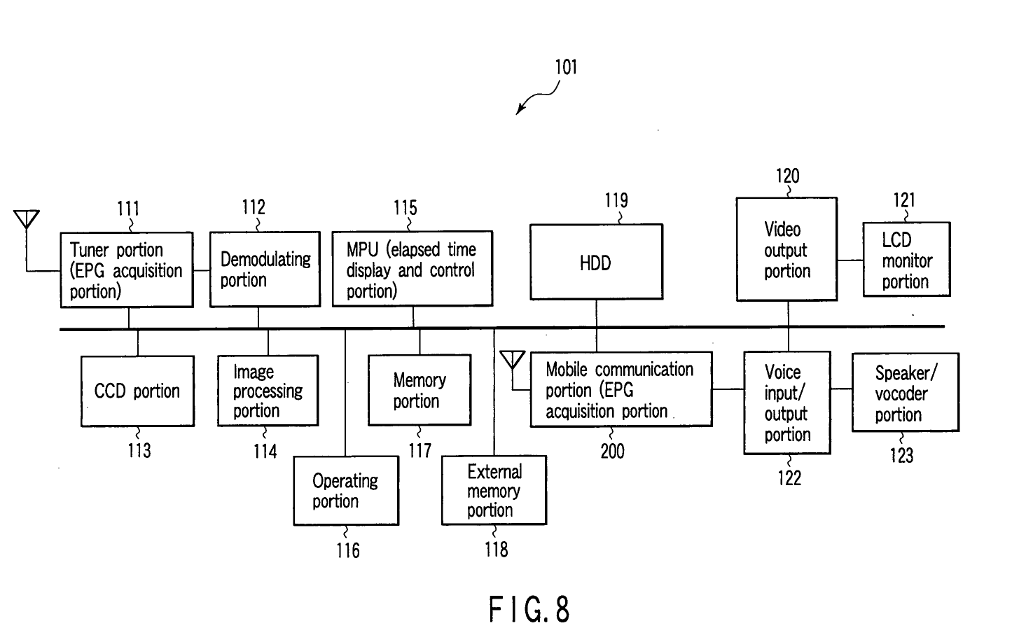

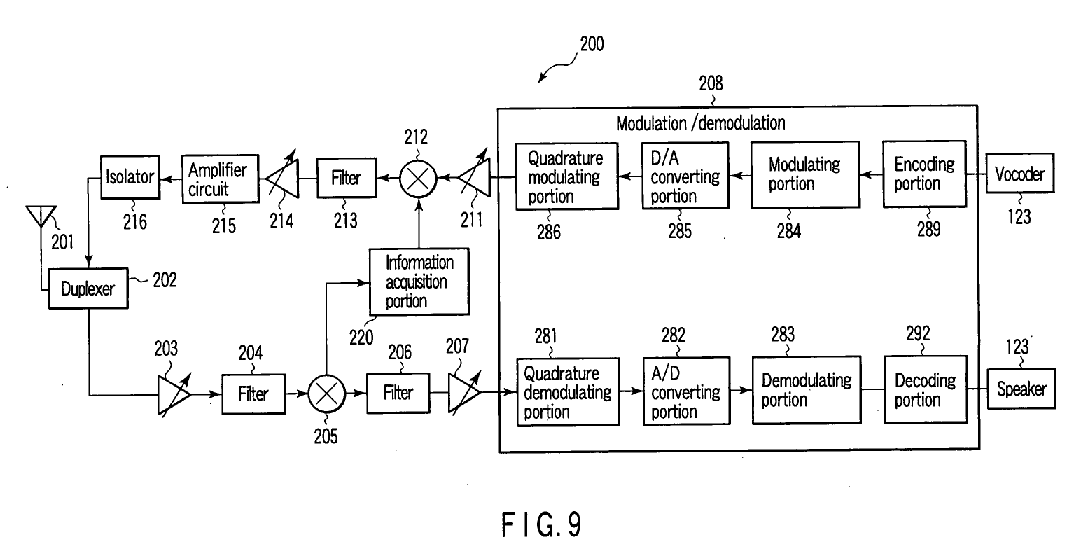

According to a fifth embodiment, there is provided an information processing apparatus capable of making a change from a broadcast screen such as a television to another screen displayed by a mobile communication portion which is a portable telephone. FIG. 8 is a block diagram depicting an example of a configuration of an information processing apparatus according to the fifth embodiment of the present invention. FIG. 9 is a block diagram depicting another example of a configuration of a mobile communication portion which the information processing apparatus includes.

In an information processing apparatus 101 according to the present invention, as shown in FIG. 8, as an example, there are provided: a tuner portion 111 for receiving a general high image quality broadcast (13-segment broadcast) which is a terrestrial digital broadcast and a low data rate broadcast (1-segment broadcast) mainly oriented to a portable TV receiver, and further, acquiring EPG (Electric Program Guidance) information which is electronic program information from a broadcast signal; and a demodulating portion 112 for demodulating them, respectively, which are connected to a bus line. Further, this information processing apparatus has a CCD portion 113 for capturing a still image or a motion image; and an image processing portion 114 for carrying out image processing of broadcast image information captured by the tuner portion 11 and the demodulating portion 112 and still image information or motion image information capture by the CCD portion 113. Furthermore, a memory portion 117 for storing a variety of programs such as a game application is provided to be connected to a bus line. Moreover, a mobile communication portion 200 for a mobile cellular phone function is provided to be connected to a bus line.

In addition, an MPU 115 for controlling a whole operation and an operating portion 116 for receiving a user operation command are provided to be connected to a bus line. This MPU 115 operates with a program or the like of the memory portion 117, thereby providing an elapsed time interval display function according to the above-described first to third embodiments. Further, the information processing apparatus 101 has an external memory portion 118 for connecting an externally removable recording medium. Furthermore, the information processing apparatus 111 has a hard disk drive 119 for storing image information, voice information and the like to be recorded, and an application program etc.; a battery portion 110 for supplying power for operating each of the units described above; a battery voltage detecting portion 124 for detecting a voltage of the battery portion 110; a video output portion 120 for processing and outputting video information such as a still image or a motion image; an LCD (Liquid Crystal Display) monitor portion 121 connected to the video output portion, for displaying a video image; and a voice input/output portion 122 for processing a voice signal and exchange the voice signal with a speaker/vocoder portion 123.

In another embodiment of the information processing apparatus according to the present invention, as a mobile TV, it is preferable that an adapter such as a tuner card for receiving a digital broadcast be connected to a device such as a portable PC, thereby functioning as a hand held TV receiver. In this case, demodulation processing in the tuner card is assumed to be compatible with both of a 13-segment broadcast and a 1-segment broadcast. In addition, the compressed and encoded video image and voice outputted from the tuner card are decoded by software under the control of the CPU of the notebook type PC. A compression and encoding scheme is generally different from another depending on the 13-segment broadcast and the 1-segment broadcast. However, in either case, decoding can be carried out by changing software.

Further, a structure of the above-described mobile communication portion 200 for a mobile cellular phone function will be described with reference to FIG. 9. The mobile communication portion 200 has an antenna 201; a duplexer 202; an RF receiving gain variable amplifier 203; an RF bandwidth restriction filter 204; a frequency converter 205; an IF bandwidth restriction filter 206; an IF receiving gain variable amplifier 207; a modulating/demodulating portion 208; an IF transmission gain variable amplifier 211; a frequency converter 212; an RF bandwidth restriction filter 213; an RF transmission gain variable amplifier 214; a power amplifier 215; an isolator 216; a vocoder 123; and a speaker 123.

In addition, the modulating/demodulating portion 208 includes: a quadrature demodulating portion 281; an A/D converting portion 282; an information signal demodulating portion 283; and a decoding portion 292. Further, this modulating/demodulating portion is composed of: an encoding portion 289 for encoding a signal from the vocoder; an information signal modulating portion 284; a D/A converting portion 285; and a quadrature modulating portion 286. In this configuration, a signal quadrature-demodulated by the quadrature modulating portion 281 is A/D converted by the A/C converting portion 282. The A/D converted signal is demodulated as an information signal by means of the signal demodulating portion 283, and the information signal is outputted after decoded by the decoding portion 292.

In such a configuration, this mobile communication portion 200 carries out reception processing as described below. A forward link signal transmitted from a base station is received by the antenna 201, and only a component in the receive signal bandwidth is filtered by the duplexer 202. The filtered component is amplified or dumped by the RF receiving gain variable amplifier 203, and an unwanted component is filtered by the RF bandwidth restriction filter 204. The filtered component is frequency-converted from an RF band to an IF band by means of the frequency converter 205, and the unwanted component is filtered by the IF bandwidth restriction filter 206. The filtered component is amplified or dumped by the IF receiving gain variable amplifier 207, and the amplified or dumped component is inputted to the modulating/demodulating portion 208.

The information acquiring portion 202 is connected to the frequency converters 205 and 212, respectively. This acquiring portion can acquire browser information over the Internet, application information such as a game, and EPG information which is electronic program information, via the frequency converter 205 and can transmit image information or operating information via the frequency converter 212. The information acquiring portion 202 is also connected to the MPU 115 or the like which is a control portion via a data bus (not shown).

The modulating/demodulating portion 208 is composed of, for example, the quadrature demodulating portion 281, the A/D converting portion 282, the information signal demodulating portion 283, the information signal modulating portion 284, the D/A converting portion 285, and the quadrature modulating portion 286.

It is preferable that the encoding portion 289 and decoding portion 292 are encoded or decoded on the basis of common encryption key information. This encoding processing prevents illegal wiretapping of voice information to be communicated. However, strictly, encryption key information for encoding from the mobile communication portion on the transmitting side and key information for the decoding portion 292 on the receiving side may be common to each other.

Reception processing of the mobile communication portion 200 having this configuration will be described below. A signal quadrature-demodulated by the quadrature demodulating portion 281 is A/D converted by the A/D converting portion 282. The A/D converted signal is demodulated as an information signal by means of the signal demodulating portion 282. Further, the modulated information signal is decoded by the decoding portion 292, and the decoded information signal is outputted as a voice to the speaker 23.

Furthermore, transmission processing of this mobile communication portion 200 will be described below. A reverse link signal transmitted from a mobile station is supplied by the vocoder 287. This signal is encoded by the encoding portion 289. The encoded signal is outputted after modulated by the information signal modulating portion 284. This signal is D/A converted by the D/A converting portion 285, and the D/A converted signal is quadrature-modulated by the quadrature modulating portion 286. The quadrature-modulated signal is amplified or dumped by the IF transmission gain variable amplifier 211, and the amplified or dumped signal is frequency-converted from the IF band to the RF band by means of the frequency converter 212. An unwanted component is filtered by the RF bandwidth restriction filter 213, and the filtered component is amplified or dumped by the RF transmission gain variable amplifier 214. The amplified or dumped component is amplified by the power amplifier 215, and only the component in the transmission signal bandwidth is filtered by the duplexer 202 via the isolator 216, and is transmitted in space by means of the antenna 201.

With the above-described configuration, the information processing apparatus 101 according to the present invention can receive a television broadcast such as a digital terrestrial wave by working of the tuner portion 11 and demodulating portion 12 under the control of the MPU 15; can record the received broadcast signal into an HDD 19 or the like; and can reproduce the recorded broadcast signal and the externally provided motion image file. Further, similarly, under the control of the MPU 15, this apparatus can record a video signal acquired from the CCD portion 13 into the HDD 19 or the like; and can reproduce the recorded motion image file. Similarly, the information processing apparatus 101 can receive and record a radio broadcast or the like by working of the tuner portion 11 and the demodulating portion 12, and further, reproduce a voice file or the like stored in the HDD 19 or the like by working of the demodulating portion 12 and the voice input/output portion 22. Similarly, this apparatus can record and reproduce a still image. Further, it is possible to play a motion image or voice specific video game or a still image specific table game according to the program stored in the memory portion 17 and HDD 19. Furthermore, under the control of the MPU 15, it becomes possible to make communication with another telephone set using a mobile cellular phone function by working of the above-described mobile communication portion 200. In addition, another application program is stored in the HDD 19 or the like, and is operated under the control of the MPU 15 or the like, whereby an arbitrary function can be executed.

In this manner, it is possible to display or control an elapsed time interval indicated in the above-described first to third embodiments. In addition, the mobile communication portion 200 having a portable telephone function or the like is provided instead of the communication portion 16 of FIG. 1, thereby displaying an elapsed time interval when a broadcast screen is changed to an application screen caused by the mobile communication portion 200 and vice versa. In this case, as an example, it is possible to make a phone call using the mobile communication portion 200 between a commercial message and a program or between two programs, to enjoy a game through communication, or to acquire EPG information by making connection to the Internet. An elapsed time interval is displayed every time a screen is changed.

That is, in the above-described information processing apparatus according to the present invention, for example, when a broadcast screen such as a television program is changed to a browser screen such as Internet by a user operation, an elapsed time interval from a time point of the change is displayed on a screen. In this manner, for example, it is possible to view the browser screen only during a commercial message of a television program, and then, return to the broadcast screen after the commercial message has terminated. It is also possible to return to the broadcast screen at a proper timing determined by the user according to the elapsed time interval information after continuously viewing the browser screen.

Furthermore, in the above-described information processing apparatus, for example, after a state in which a television program is displayed has been changed to a browser screen, a remaining time for a next program of that broadcast channel to start is displayed on a screen by making calculation from the acquired electronic program information and current time. In this manner, the user can avoid missing a start portion of the next program due to immersion into viewing of the browser screen. Thus, viewing of the broadcast screen such as a television program and viewing of the browser screen can be properly compatible with each other.

The present invention can be carried out by one skilled in the art in accordance with a variety of embodiments described above. Further, it would have been obvious to one skilled in the art to conceive various modifications of these embodiments, and the present invention can be applied to a variety of embodiments even if one skilled in the art does not have inventive ability. Therefore, the present invention covers broad range without deviating from the disclosed principle and novel features, and is not limited to the above-described embodiments.

1. An information processing apparatus comprising:
a receiving portion which receives a broadcast signal and outputs a video signal;
a communication portion which outputs an image signal on the basis of a signal acquired via a network;
a display portion which displays at least one of the video signal from the receiving portion and the image signal from the communication portion; and
a control portion which, upon receipt of the video signal from the receiving portion and the image signal from the communication portion, controls the video signal to be supplied as a first display to the display portion according to a command signal, then changes the display and controls the image signal to be supplied as a second display to the display portion, and further, an elapsed time interval from the change to be displayed on the display portion.

2. An information processing apparatus according to claim 1, wherein, when a predetermined time interval has elapsed from change of the screen, the control portion controls the display portion to display that the predetermined time interval has elapsed.

3. An information processing apparatus according to claim 1, wherein, when a predetermined time interval has elapsed from change of the screen, the control portion controls the display portion to indicate that the predetermined time interval has elapsed with a display color of the elapsed time interval or font change, or alternatively, by blinking the display.

4. An information processing apparatus according to claim 1, wherein, when a predetermined time interval has elapsed from change of the screen, the control portion controls such an elapsed time interval to be warned by voice.

5. An information processing apparatus according to claim 1, wherein, when a predetermined time interval has elapsed from change of the screen, the first display is changed to the second display.

6. An information processing apparatus according to claim 1, wherein the control portion has a mode for automatically changing a screen in units of programs, and, when this mode is selected, the control portion detects change of a program of the broadcast signal received by the receiving portion, and controls the second display to be changed to the first display.

7. An information processing apparatus according to claim 1, further comprising:
a voice detecting portion which detects a voice and outputs a detection signal;
a modulating portion which modulates the detection signal and outputs a modulation signal;
an antenna portion which transmits the modulation signal to an external base station;
a demodulating portion which receives a second modulation signal transmitted from the external base station via the antenna portion, and demodulates the received signal to output a demodulation signal; and
a speaker portion which generates a voice according to the demodulation signal demodulated by the demodulating portion.

8. An information processing apparatus comprising:
a receiving portion which receives a broadcast signal and outputs a video signal;
a communication portion which outputs an image signal on the basis of a signal acquired via a network;
an acquisition portion which acquires electronic program information on the broadcast signal;
a display portion which displays at least one of the video signal from the receiving portion and the image signal from the communication portion; and
a control portion which, upon receipt of the video signal from the receiving portion and the image signal from the communication portion, controls the video signal to be supplied as a first display to the display portion according to a command signal, then changes the display and controls the image signal to be supplied as a second display to the display portion, and further, an elapsed time interval from the change to be displayed on the display portion.

9. An information processing apparatus according to claim 8, wherein, when a remaining time for the next program to start becomes a predetermined time interval, the control portion controls the display portion to display the remaining time for the next program to start.

10. An information processing apparatus according to claim 8, wherein the control portion changes the second display to the first display before a predetermined time interval for the next program to start or when the next program starts.

11. An information processing apparatus according to claim 8, wherein the control portion sets a specification changing a screen, and changes the second screen to the first screen on the basis of the set specification.

12. An information processing apparatus according to claim 8, wherein, after program reservation has set on the basis of the electronic program information from the acquisition portion to change the first screen to the second screen, when a program according to the program reservation starts, the control portion controls a screen from the second screen to the first screen.

13. An information processing apparatus according to claim 8, further comprising:
a voice detecting portion which detects a voice and outputs a detection signal;
a modulating portion which modulates the detection signal and outputs a modulation signal;
an antenna portion which transmits the modulation signal to an external base station;
a demodulating portion which receives a second modulation signal transmitted from the external base station via the antenna portion, and demodulates the received signal to output a demodulation signal; and
a speaker portion which generates a voice according to the demodulation signal demodulated by the demodulating portion.

14. An information processing method comprising:
receiving a broadcast signal and outputting a video signal;
outputting an image signal on the basis of a signal acquired via a network;
controlling the video signal to be supplied as a first display to the display portion according to a command signal, then controlling the video signal to be supplied as a first display to the display portion according to a command signal, then changing the display and controlling the image signal to be supplied as a second display to the display portion, and further, an elapsed time interval from the change to be displayed on the display portion.

15. An information processing method according to claim 14, wherein, when a predetermined time interval has elapsed from change of the screen, the controlling controls the display portion to display that the predetermined time interval has elapsed.

16. An information processing method according to claim 15, wherein, when a predetermined time interval has elapsed from change of the screen, the controlling controls the display portion to indicate that the predetermined time interval has elapsed with a display color of the elapsed time interval or font change, or alternatively, by blinking the display.

17. An information processing method comprising:
receiving a broadcast signal and outputting a video signal;
outputting an image signal on the basis of a signal acquired via a network;
acquiring electronic program information on the broadcast signal;
upon receipt of the video signal and the image signal, controlling the video signal to be supplied as a first display to the display portion according to a command signal, then the supplied display to be changed to the image signal, then changing the display and controlling the image signal to be supplied as a second display to the display portion, and further, an elapsed time interval from the change to be displayed on the display portion.

18. An information processing method according to claim 17, wherein, when a remaining time for the next program to start becomes a predetermined time interval, the controlling controls the display portion to display the remaining time for the next program to start.

19. An information processing method according to claim 17, wherein the controlling changes the second display to the first display before a predetermined time interval for the next program to start or when the next program starts.

20. An information processing method according to claim 17, wherein the controlling sets a specification changing a screen, and changes the second screen to the first screen on the basis of the set specification.
